(19) United States
(12) Patent Application Publication
(10) Pub. No.: US 2007/0089338 A1
(43) Pub. Date: Apr. 26, 2007

(54) Handheld lighted support wand and banner

(75) Inventors: Andrew Barnhouse, El Paso, TX (US); Steve Abraham, Tijeras, NM (US)

Correspondence Address: PEACOCK MYERS, P.C., 201 THIRD STREET, N.W., SUITE 1340, ALBUQUERQUE, NM, 87102, US

(73) Assignee: Odyssey Lighting and Manufacturing, Albuquerque, NM (US)

(21) Appl. No.: 11/430,649

(22) Filed: May 8, 2006

Related U.S. Application Data
(63) Continuation-in-part of application No. 10/618,518, filed on Jul. 11, 2003.
(60) Provisional application No. 60/679,039, filed on May 6, 2005.
(60) Provisional application No. 60/395,742, filed on Jul. 12, 2002.

(51) Int. Cl. G09F 17/00

(52) U.S. Cl. 40/604

(57) ABSTRACT

An apparatus and method for illuminating a banner, flag, or pennant, in addition to illuminating substantially the entire length of a support, such as a flagpole. In the preferred embodiment, a lighting element is placed inside a transparent or partially or wholly translucent support, thereby illuminating the support as well as the banner. A handheld embodiment preferably comprises a handle with a switch and finger grips.

### CROSS-REFERENCE TO RELATED APPLICATIONS

This application claims the benefit of the filing of U.S. Provisional Patent Application Ser. No. 60/679,039, entitled “Lighted Support Pole and Banner”, filed on May 6, 2005. This application is also a continuation-in-part application of U.S. patent application Ser. No. 10/618,518, entitled “Lighted Support Pole and Banner”, filed on Jul. 11, 2003, which claims the benefit of the filing of U.S. Provisional Patent Application Ser. No. 60/395,742, entitled “Luminescent Support Pole,” filed on Jul. 12, 2002. The specifications and claims of all of the above references are incorporated herein by reference.

### BACKGROUND OF THE INVENTION

1. Field of the Invention (Technical Field)

The present invention relates generally to support poles, and more particularly, but not necessarily entirely, to a lighted support pole for illuminating and hanging a banner.

2. Background Art

Note that the following discussion refers to a number of publications by author(s) and year of publication, and that due to recent publication dates certain publications are not to be considered as prior art vis-a-vis the present invention. Discussion of such publications herein is given for more complete background of the scientific principles and is not to be construed as an admission that such publications are prior art for patentability determination purposes.

Proper flag displaying etiquette requires a flag to be properly displayed during both daytime and nighttime hours. There are several different types of flags that have become increasingly popular to display, such as national flags, advertising and organizational flags, as well as pennants flying on flagpoles. Typically, these flags are poorly lit or not visible during nighttime hours, violating proper flag etiquette. Proper flag etiquette requires that flags and pennants be visible at any time of the day or night and at any time of the year.

In fact, at one point the United States of America codified the manner in which the flag of the United States should be treated in what was known as the “Flag Code,” 36 U.S.C. §173-178. The following is an example of what was contained therein.

“Display on buildings and stationary flagstaffs in open; night display: It is the universal custom to display the flag only from sunrise to sunset on buildings and on stationary flagstaffs in the open. However, when a patriotic effect is desired, the flag may be displayed twenty-four hours a day if properly illuminated during the hours of darkness.” (36 U.S.C. §174)

Various solutions to improve the visibility of flags and pennants at night are known in the art. The most widely recognized solution makes use of floodlights to improve the visibility of such flags. However, depending on the voltage range used, floodlights are often difficult to install and the investment of properly illuminating the flag and the subsequent costs of operating floodlights can be very expensive.

Accordingly, the prior art contains various solutions relating to flagpole lighting and properly illuminating flags and pennants. For example, U.S. Pat. No. 6,227,603 (issued May 8, 2001 to Tukia) discloses a flagpole light in the form of a luminous knob comprising a light source having a cover and emits light rays that are reflected from reflecting surfaces through a translucent lower portion of the cover for mounting on existing flagpoles or during manufacturing. However, this lighting system is disadvantageous because it does not adequately light the flag and does not illuminate the pole upon which the flag or pennant may be attached. Therefore, this invention is unable to adequately illuminate both the flag and the pole.

U.S. Pat. No. 3,476,929 (issued Nov. 4, 1969 to Klinger) discloses a hollow tubular metal mast having a ground penetrating point at its lower end and a reflector cone, including lenses and a light source, at its top end for illuminating a pennant flying at the top of the mast. This invention is disadvantageous because the metal mast is not transparent and does not allow light to pass therethrough, making it impossible to illuminate the pole.

U.S. Pat. No. 1,878,447 (issued Sep. 20, 1932 to Sutphen) discloses a flagpole comprising a translucent material and lights, but this invention illuminates only the top portion of the pole.

U.S. Pat. No. 4,598,339 (issued Jul. 1, 1986 to Ainsworth) discloses a transparent tubular pole with lights and circuit board which serves as a safety light for a bicycle. This invention is disadvantageous because it does not support a flag, the entire pole structure is not illuminated, and the lights would not adequately illuminate a flag if one were added.

It is noteworthy that none of the prior art known to applicant provides a lighted pole and banner assembly capable of illuminating both the flag, or pennant, and the entire pole upon which the flag is attached. There is a long felt, but unmet need, for a lighted pole and banner assembly that is relatively inexpensive to make, simple in operation and which illuminates both the pole and the flag for nighttime display.

The prior art is thus characterized by several disadvantages that are addressed by the present invention. The present invention minimizes, and in some aspects eliminates, the above-mentioned failures, and other problems, by utilizing the methods and structural features described herein.

### SUMMARY OF THE INVENTION (DISCLOSURE OF THE INVENTION)

The present invention is a lighted pole and banner assembly comprising an elongated support, such as a flagpole, a banner such as a flag, banner, or pennant, and a light source that illuminates both the banner and at least portions of the support substantially along the length of the support. The support may be wholly or partially translucent or transparent, and include areas of differing colors and translucencies. The light source may be situated inside the support or on its surface, and may extend along the entire length of the support.

The light source may include multiple lighting elements, which might be turned on and off independently and might vary in color and brightness. Such elements may include incandescent filaments, rope lights, fluorescent lights, neon gas bulbs, filament lamps, spring lamps, tube lamps, light emitting diodes, fiber optic lights, and the like. The operation of the light source may be controlled by a programmable controller, a timer, a photocell, or a combination thereof. The light source may be powered by current from a power grid, a transformer, a generator, a battery, a 12 volt adaptor such as a vehicle cigarette lighter, or a solar cell. The battery may be rechargeable, optionally by a solar cell.

The invention is further a luminescent support pole mounted to a transportation vehicle, such as an automobile, van, truck, motor home, motorcycle, or bicycle.

The invention is also a method for illuminating a banner comprising the steps of attaching a banner to an elongated support and illuminating the banner and at least one portion substantially along the support with a light source. The support may be wholly or partially translucent. The light source may be placed within the support. The color and intensity of the illumination provided by the light source may be varied. The operation of the light source may be automatically controlled.

The invention is yet further a handheld lighted wand and banner assembly comprising a handle, a support attached to the handle, the support comprising a hollow cylinder having no openings in its lateral surface, one or more lighting elements disposed within the support, and a banner attached to the support, wherein the one or more lighting elements at least partially illuminate the banner and at least one portion of the support along substantially an entire length of the support. The support is preferably clear, transparent, or translucent. The light elements are preferably selected from the group consisting of light emitting diodes, rope lights, neon lights, light bulbs, fluorescent lights, filament lamps, incandescent lights, and fiber optics. The light elements preferably comprise a characteristic selected from the group consisting of blinking, sequential illumination, patterned illumination, random illumination, single color, multiple colors, and varying brightness. The support preferably comprises a material selected from the group consisting of polymer, acrylic, and polystyrene. The handle preferably comprises finger grips and a switch for operating the assembly. The assembly preferably further comprises a vibrator motor. The banner is preferably directly affixed to the support.

The present invention is also a method for illuminating a handheld tube and banner assembly comprising the steps of providing a support comprising a hollow cylinder having no openings in its lateral surface, disposing one or more light elements within the support, attaching a handle to the support, affixing a banner to the support, illuminating at least one portion of the support along substantially an entire length of the support, and at least partially illuminating the banner. The support is preferably clear, transparent, or translucent. The light elements are preferably selected from the group consisting of light emitting diodes, rope lights, neon lights, light bulbs, fluorescent lights, filament lamps, incandescent lights, and fiber optics. The method preferably further comprises a step selected from the group consisting of blinking at least one of the light elements, sequentially illuminating the light elements, illuminating the light elements in a pattern, randomly illuminating the light elements, varying a color of the light elements, varying a brightness of the light elements, and vibrating the assembly. The support preferably comprises a material selected from the group consisting of polymer, acrylic, and polystyrene. The method preferably further comprises the step of gripping the handle. The method also preferably further comprises the step of operating a switch disposed on the handle. The affixing step preferably comprises affixing the banner directly to the support. The affixing step optionally comprises inserting the support into at least one grommet and affixing a cap to a top of the support. The attaching step also optionally comprises inserting the support into an opening in the handle.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is a side view of a lighted pole and banner assembly made in accordance with the principles of the present invention;

FIG. 1A is a side view of the lighted pole and banner assembly attached to a structure via a support bracket, made in accordance with the principles of the present invention;

FIG. 2 is a side, cross-sectional view of an light source of the lighted pole and banner assembly of FIG. 1, taken along section 2-2,

FIG. 3 is a cross sectional view of the light source taken along section 3-3 of FIG. 1;

FIG. 4 is a side view of an alternative embodiment illustrating a neon-illuminated support pole that is comprised of shorter units assembled into a longer pole made in accordance with the principles of the present invention;

FIG. 5 is a side view of an alternative embodiment illustrating a neon-illuminated support pole made in accordance with the principles of the present invention;

FIG. 6 is a side view of another alternative embodiment illustrating a neon-illuminated support pole made in accordance with the principles of the present invention;

FIG. 7 is a side view of a bottom portion of the invention installed in rock or another hard material;

FIG. 8A is a detail of a spacer used in FIG. 6;

FIG. 8B is a detail of a washer used in FIG. 5;

FIG. 8C is a detail of a tube assembly cushion washer used in FIG. 5;

FIG. 8D is a detail of a seating cushion used in FIG. 5;

FIG. 8E is a detail of a cushion washer used in FIG. 4;

FIG. 8F is a detail of a coupler used in FIG. 6;

FIG. 9 is an alternative embodiment of the invention utilizing a tube lamp;

FIG. 10 is an alternative embodiment of the invention utilizing a spring lamp;

FIGS. 11A, 11B, and 11C depict front, end, and side views respectively of a preferred handle of a handheld embodiment of the present invention;

FIGS. 12A and 12B depict cutaway and perspective views respectively of the handle of FIG. 11; and

FIG. 13 depicts a handheld embodiment of the present invention.

### DESCRIPTION OF THE PREFERRED EMBODIMENTS (BEST MODES FOR CARRYING OUT THE INVENTION)

A nation's flag or any other type of flag may be properly displayed during nighttime hours by illuminating the flag using a clear light transparent support pole that may be internally illuminated, thus illuminating and displaying the flag in an appropriate manner. The present invention is a unique, novel support pole that may be advantageously used both during the day and at night without the necessity of taking down the flag during nighttime hours due to improper display as required by proper flag etiquette. The present invention is a lighted pole and banner assembly that optionally may be easily attached to a structure to support any type of flag.

As used throughout the specification and claims, the term “banner” means flag, pennant, ensign, banner, insignia, and the like, including any other object that may be displayed on a pole.

As used throughout the specification and claims, the term “support” means pole, flagpole, beam, wand, arm, stick, and the like.

As used throughout the specification and claims, the term “light source” means incandescent filament, rope light, fluorescent light, neon gas bulb, filament lamp, spring lamp, tube lamp, light emitting diode, fiber optic light, and the like.

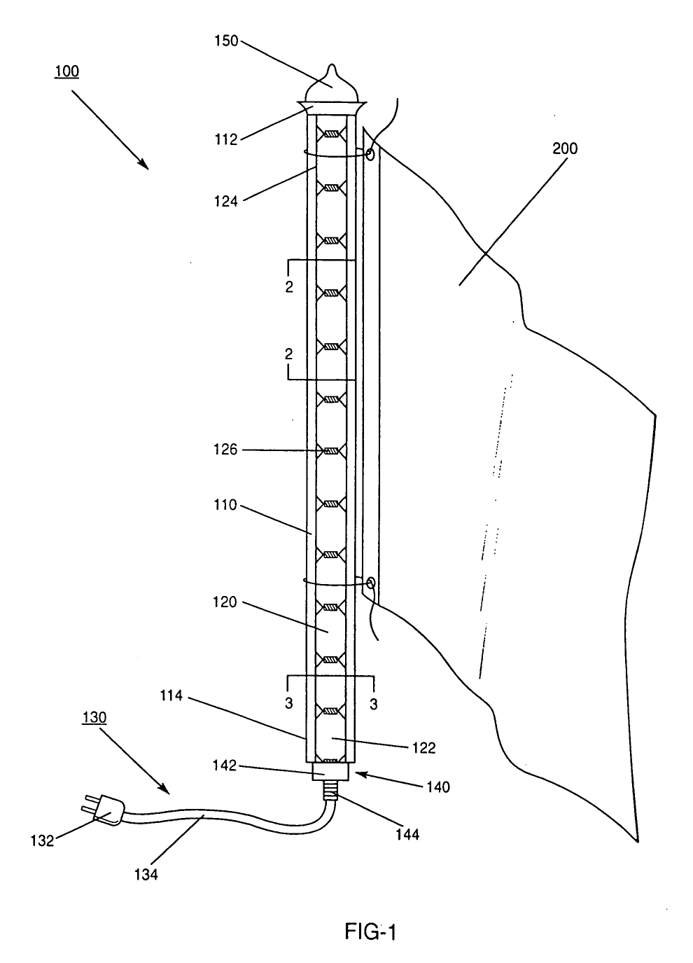

Referring now to FIGS. 1 and 1A, wherein lighted pole and banner assembly, generally referred to as 100, is illustrated, comprising support 110, light source 120, conductor 130, connector 140, cap 150 and banner 200. Support 110 may be illuminated at night such that proper flag displaying etiquette may be closely observed. The following structural features of support 110 may advantageously be associated with the novel function of illuminating lighted pole and banner assembly 100. It should be noted that support 110 may be manufactured from a clear acrylic, other transparent materials, luminescent materials, or translucent materials such that light may pass therethrough illuminating, fully or at least partially, support 110. In addition, support 110 may have non-uniform light transmitting characteristics. Such non-uniform characteristics may be inherent to the material support 110 is constructed of, or may be imparted to support 110 by partially covering it, painting it, or otherwise modifying or decorating it. For example, support 110 may be completely transparent; alternatively it may be opaque at the bottom, translucent in the middle, and transparent at the top adjacent to the flag, optionally, support 110 may be opaque everywhere except for the side of the pole to which the flag is attached, where it may be transparent. Another embodiment provides for support 110 to be substantially opaque except for a transparent or translucent design, such as stars or other shapes, integrated into support 110. Optionally, support 110 may be translucent and colored, with a single uniform color, multiple colors, or colored designs. As can be appreciated by those skilled in the art, the present invention includes any combination of varying sections, degrees of transparency or translucency, colors, design features, etc.

Additionally, support 110 may be configured as a hollow tube for receiving light source 120 therein and may be dimensioned according to the size, including the length and dimension, of light source 120. For example, the wall thickness of support 110 may lie within the range of about 1 mm to about 15 mm without departing from the scope of the present invention. It should be noted that any wall thickness may be utilized in the present invention and may be readily determined by one of skill in the art depending upon the desired length and diameter of support 110 to be manufactured.

Additionally, support 110 may be manufactured in various lengths and diameters, some examples of which have been reproduced below in a table for convenience. It should be noted, however, that the dimensions listed below are in no way intended to limit the scope of the present invention and have been provided herein for enablement purposes.

| LENGTH OF SUPPORT | DIAMETER OF SUPPORT |
|---|---|
| 1½ feet | ½ inch, 1½ inches, 1⅜ inches, 2 |
| | inches, 2½ inches, and 3 inches |
| 2 feet | ½ inch, 1½ inches, 1⅜ inches, 2 |
| | inches, 2½ inches, and 3 inches |
| 2½ feet | ½ inch, 1½ inches, 1⅜ inches, 2 |
| | inches, 2½ inches, and 3 inches |
| 3 feet | ½ inch, 1½ inches, 1⅜ inches, 2 |
| | inches, 2½ inches, and 3 inches |
| 3½ feet | ½ inch, 1½ inches, 1⅜ inches, 2 |
| | inches, 2½ inches, and 3 inches |
| 4 feet | ½ inch, 1½ inches, 1⅜ inches, 2 |
| | inches, 2½ inches, and 3 inches |
| 4½ feet | ½ inch, 1½ inches, 1⅜ inches, 2 |
| | inches, 2½ inches; and 3 inches |
| 5 feet | ½ inch, 1½ inches, 1⅜ inches, 2 |
| | inches, 2½ inches, and 3 inches |
| 5½ feet | ½ inch, 1½ inches, 1⅜ inches, 2 |
| | inches, 2½ inches, and 3 inches |
| 6 feet | ½ inch, 1½ inches, 1⅜ inches, 2 |
| | inches, 2½ inches, and 3 inches |

As shown in the drawings, support 110 preferably comprises first end 112 and second end 114. The first end 112 of support 110 may optionally be equipped with cap 150 for decoratively finishing support 110 for a more impressive appearance. Cap 150 not only serves the function of providing an impressive finished appearance, but also acts as a barrier such that light source 120 may not escape from support 110 and to protect light source 120 from the weather. It should be noted that cap 150 may be manufactured from materials known in the art to provide a finished appearance and that acts as a barrier. Examples of such materials include, but are not limited to, polymers, such as plastic, vinyl, or rubber, and metallic materials such as brass, spun aluminum, gold, silver, chrome, or any other metal or metal alloys, and the like.

Referring generally to FIG. 1 and 1A, light source 120 may be configured to be located within the hollow portion of support 110. Light source 120 may enter support 110 through second end 114 and may be secured thereto by a means for securing light source 120 within support 110. Light source 120 may be comprise first end 122 and second end 124 with a plurality of incandescent filaments 126 disposed therebetween. First end 122 comprises a coupler configured for coupling light source 120 to conductor 130, while second end 124 comprises a point of termination, where incandescent filaments 126 of light source 120 conclude.

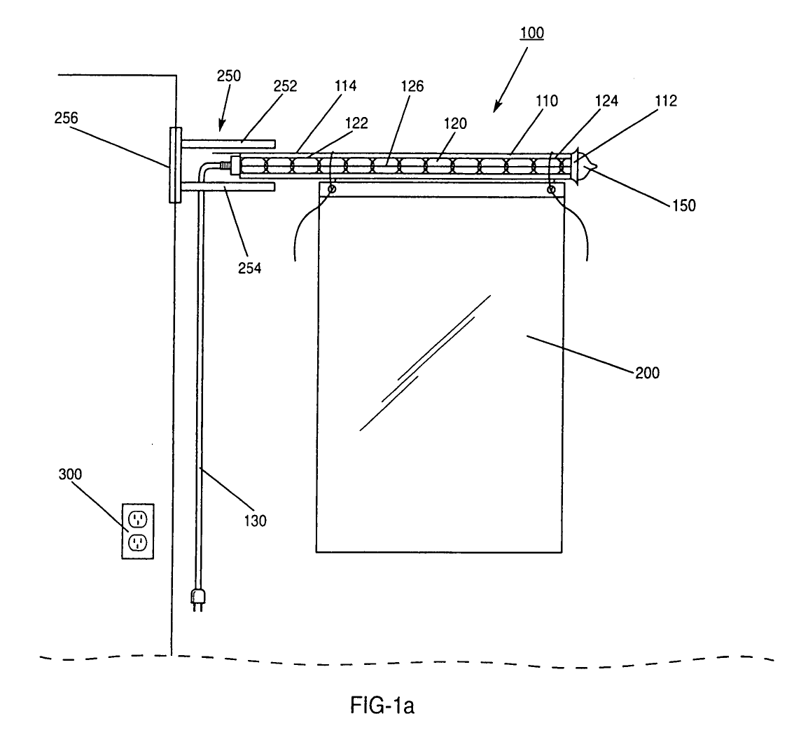

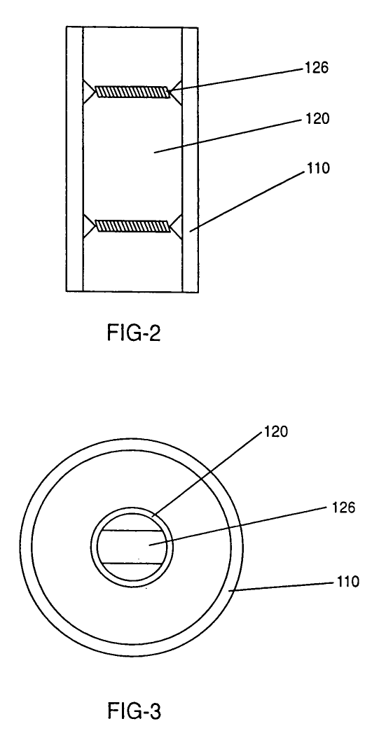

Referring specifically to FIG. 2, wherein an enlarged side cross-sectional view of the light source of FIG. 1 is illustrated, incandescent filaments 126 may be part of an intricate electrical system providing a source of illumination when a current is conducted therethrough. FIG. 3 is a cross-sectional view taken along the line 3-3 of FIG. 1, and illustrates incandescent filament 126 as part of light source 120 in relation to support 110. It should be noted that incandescent filament 126 is only one illustrative embodiment of structure that provides the illumination emanating from light source 120. It should be noted that other light sources are contemplated by the present invention, including but not limited to fluorescent lights, neon gas lights, filament lamps, light emitting diodes (commonly known as “LED's”), fiber optics, as well as other devices known, or which may become known in the future, in the art to emit energy creating illumination.

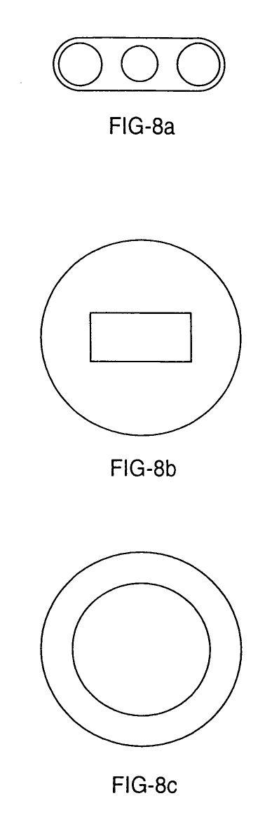

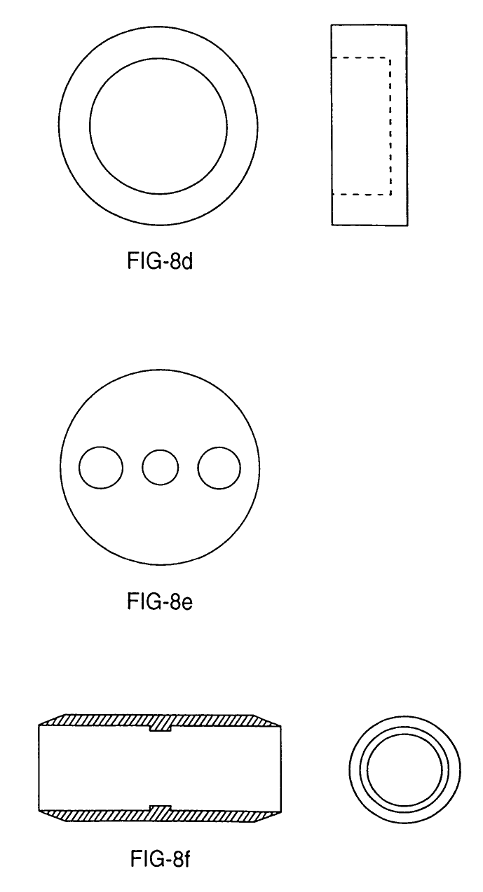

One embodiment of light source 120 of the present invention comprises a rope light configured for maintaining the above described incandescent filament 126 or other device known to emit energy creating illumination. Rope light is known in the art to be flexible and adaptable. It will be appreciated by those of skill in the art that several structural components may be used to increase the flexibility and adaptability of the rope light, such as a connector for connecting two cut pieces of rope lighting, rope light controllers, rope light track, splicing pieces, clips, transformers, rope light extensions, as well as other components familiar to one of skill in the art. It should be noted that light source 120 may be a rope light as illustrated, a neon light assembly (illustrated in FIGS. 8-19) or any other device configured for maintaining the above-described structural features that emit energy creating illumination.

Additionally, light source 120 may be configured in a variety of colors to match the colors of banner 200 used. For example, a United States flag may have red lights, white lights, and blue lights such that light source 120 illuminates all three colors. Light source 120 may illuminate only a single color or it may illuminate a combination of several colors depending upon the desired affect. Colors of light source 120 may be created using either colored incandescent filaments 126, or light source 120 itself may be colored. Colors of incandescent filaments 126 include, but are not necessarily limited to, clear, red, yellow, green, amber, blue, and purple, while colors of light source 120 include, but are not necessarily limited to, clear (white), red, yellow, green, amber, blue, purple, fluorescent green, fluorescent orange, and fluorescent pink.

In addition, the brightness of light source 120 may vary according to the height along support 110 or direction relative to banner 200. For example, the illumination may be stronger adjacent to the banner. Optionally the brightness and the colors may be varied as desired, by dimming or turning on and off various lighting elements or sections of light source 120 as required to obtain the desired effect. This may be achieved by utilizing a programmable control apparatus. For example, light source 120 may blink on and off, optionally with each succeeding blink being a different color. In another embodiment, different heights or sections of light source 120 may be darkened or illuminated sequentially in a desired pattern. In yet another embodiment messages may be displayed by illuminating LED's as desired.

It should likewise be noted that light source 120 may be located within support 110, but one of skill in art may modify support 110 to receive light source 120 on any portion of support 110 without departing from the scope of the present invention. For example, support 110 may have light source 120 integrally formed within support 110, or may have light source 120 secured to the outer portion of support 110. For example, a lighting element may be attached along the length of, or spiraled around the outside of, a pole. This last embodiment allows for retrofitting a lighting element contemplated herein to an existing pole.

Referring back to FIGS. 1 and 1A, second end 114 of support 110 may be configured to receive connector, generally referred to as 140, that maintains light source 120 within support 110 and couples conductor 130 with light source 120. Connector 140 may be configured and dimensioned to fit either inside of second end 114 of support 110 or it may fit outside of second end 114 such that connector 140 essentially wraps around said second end 114. As illustrated in FIGS. 1 and 1A, connector 140 may comprise first cylindrically shaped portion 142 and second cylindrically shaped portion 144.

As illustrated, first portion 142 may be larger in size than second portion 144. However, it should be noted that first portion 142 may be smaller than second portion 144, or first portion 142 and second portion 144 may be equal in size. Additionally, connector 140 may be manufactured from a clear acrylic, plastic, or other polymeric material. It should be further noted that connector 140 may be shaped in a plurality of different shapes without departing from the scope of the present invention, and one of skill in the art may modify connector 140 to be of any suitable shape. For example, connector 140 may be circular or cylindrical (as illustrated), square, any polygonal shape, or any other suitable shape for coupling conductor 130 to light source 120 and maintaining light source 120 within support 110. It will be appreciated that the structure disclosed herein for connector 140 may be two distinct portions as illustrated, or it may be a single unit, or it may be multiple parts. One of skill in the art may modify the connector to accommodate various sized supports 110 and any such modification of connector 140 is contemplated by the present invention.

As illustrated in FIGS. 1 and 1A, conductor 130 functions to provide power via an electric current to light source 120 and specifically conducting electric current to the coupler of first end 122 of the light source 120. As illustrated, conductor 130 may comprise plug 132 and power cord 134. Plug 132 may be configured and dimensioned to fit into any electrical outlet, such as a standard 110 volt electrical outlet commonly used in the United States, or a standard 220 volt electrical outlet commonly used outside of the United States. Plug 132 connects to power cord 134 and allows the conduction of the electrical current from electrical outlet 300, or other electrical source, to light source 120 in an amount sufficient to cause light source 120 to react and illuminate.

Conductor 130 has been illustrated herein as one that conducts electrical current via electrical plug 132 and power cord 134. It should be noted that power source 300 of the current may be an electrical outlet, an illustrated in FIGS. 1 and 1A, a battery (not illustrated), a transformer, a generator, a solar cell, or any other source capable of producing enough current at a suitable voltage to illuminate light source 120. The battery may be a replaceable or rechargeable, optionally being recharged by a solar cell during daylight hours. The power source may optionally be connected to a timer or a photocell so that light source 120 is, for example, turned on automatically at dusk and turned off automatically at dawn. It should be noted that one of skill in the art may modify conductor 130 to correspond with the appropriate power source 300 and conductor 130 may be modified as power source 300 is modified. For example, by changing power source 300 from a standard electrical outlet to a battery, conductor 130 will likewise need to be modified to connect the battery thereby creating a conduit for the conduction of current from power source 300 to light source 120.

Also illustrated in FIG. 1A, is support bracket, generally referred to as 250. Support bracket 250 has first arm 252 and second arm 254 extending from bracket attachment 256. Support bracket 250 may be configured and dimensioned to accept lighted pole and banner assembly 100 therein.

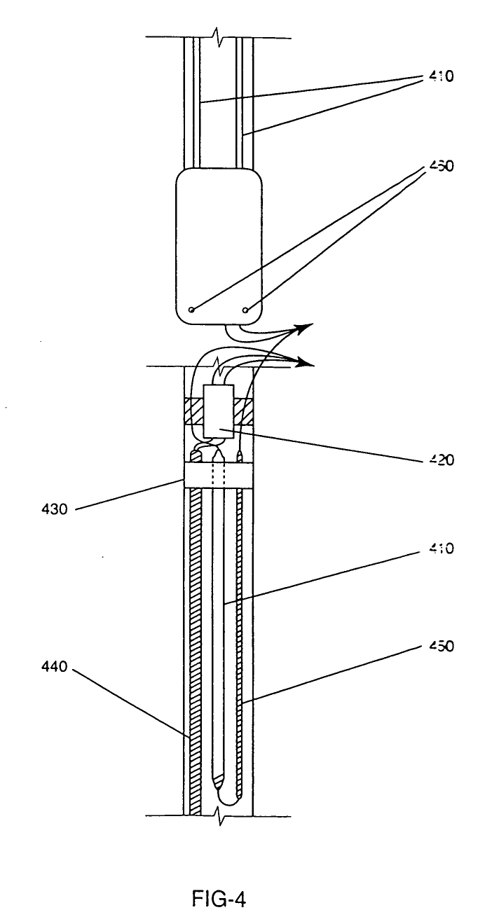

FIG. 4 illustrates an embodiment of the invention in which two sections of support 110 are assembled to make a longer illuminated flag pole. In this embodiment, the light source comprises neon lights 410, transformer 420 within the pole 110, AC power cable 440, wire 450 connecting the bottom of neon light 410 to transformer 420, cushion washer 430 to center neon bulb and wires 440 and 450, and set screws 460 to hold the assembly together. Cushion washer 430 preferably comprises black foam elastomer and is detailed in FIG. 8E.

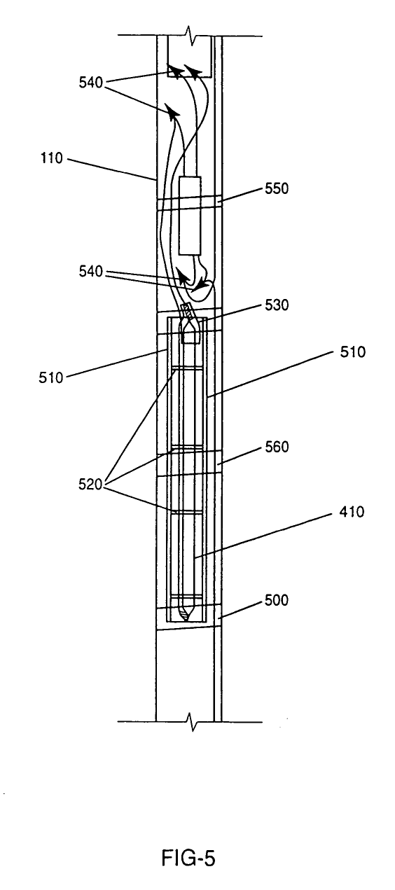

FIG. 5 details an alternate method of disposing a neon lighting element inside support 110. The neon tube assembly comprises a tube assembly comprising neon tube 410 and two parallel acrylic tubes 510 held together by series of spacers 520 (preferably comprising clear acrylic), electrical boot 530, twist-on wire connectors 540, washer 550 (preferably comprising black foam elastomer and detailed in FIG. 8B), tube assembly cushion washer 560 (preferably comprising black foam elastomer and detailed in FIG. 8C), and seating cushion 570 (preferably comprising black foam elastomer and detailed in FIG. 8D).

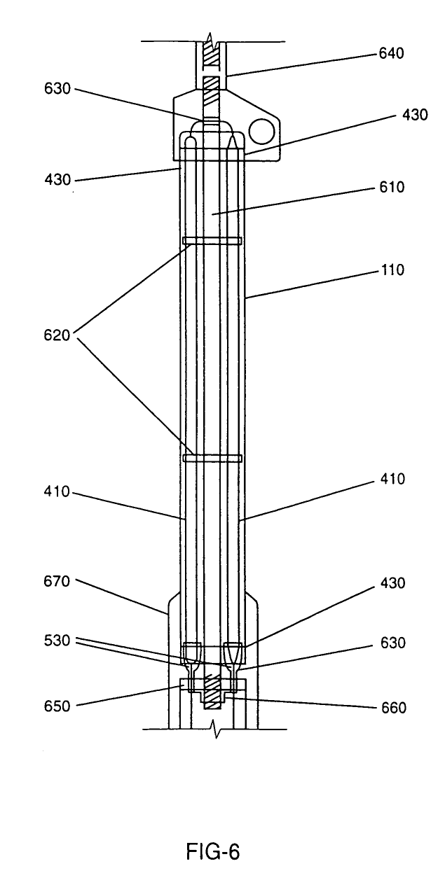

FIG. 6 illustrates another alternate embodiment of disposing a neon lighting element inside support 110. Here support 110 comprises a tube (e.g. 3 inch diameter and preferably acrylic). Two neon tubes 410 are connected to a rod 610 (e.g. ½ inch diameter, preferably threaded and preferably aluminum) by multiple spacers 620 (preferably comprising clear acrylic and detailed in FIG. 8A). The apparatus further comprises butt connectors 630, electrical boots 530, brass coupling nut 640, cushion washers 430, aluminum washer 650, steel locknut 660, and coupler 670 (preferably comprising aluminum and detailed in FIG. 8F).

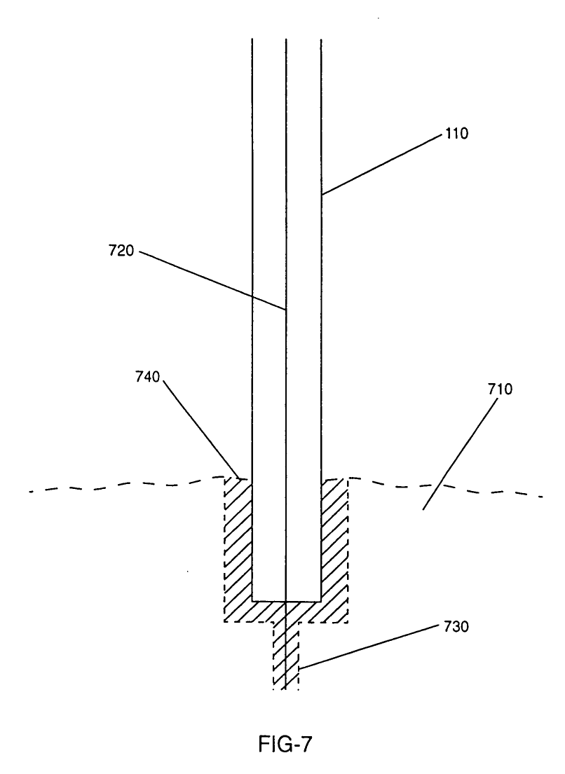

FIG. 7 is an illustration of an example of an outdoor installation of the invention, detailing the placement of the bottom of support 110 into rock 710. Waterproof wire 720 runs from a power source, through hole 730 in rock 710 and through support 110 up to the light source. A hole filled with material 740, such as sand or cement, secures support 110 in place.

FIG. 8 contains details of components used in the embodiments of the invention depicted in previous figures.

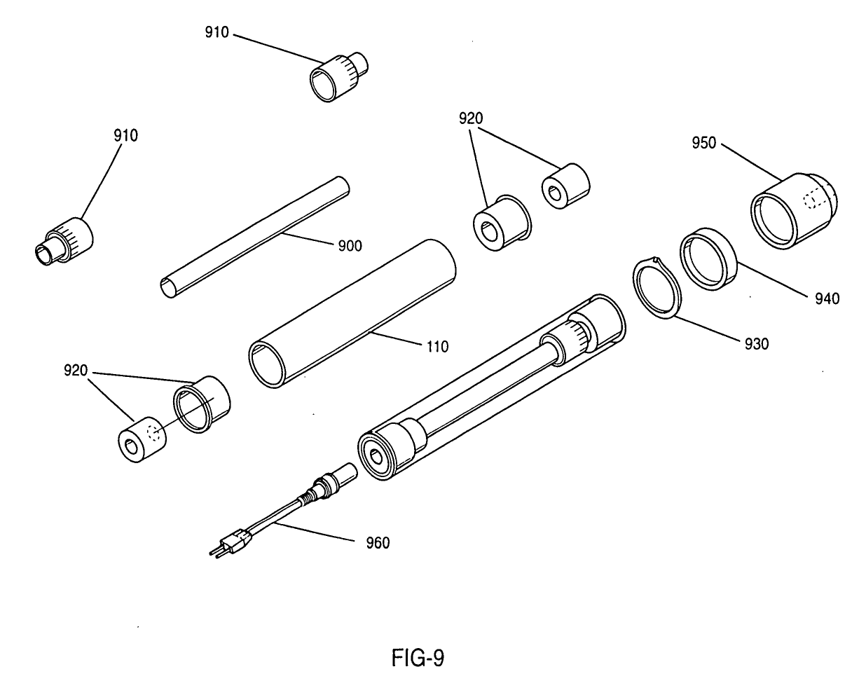

FIG. 9 is an alternate embodiment of the invention wherein the light source comprises tube lamp 900. Support 110 comprises a tube, preferably Flexglass. The tube lamp is secured within the support by attaching each end to connector 910 (preferably comprising PVC), which is then situated in coupling 920 (also preferably comprising PVC). One end of the assembly is sealed with ring 930 (e.g. Flexglass), ring 940 (e.g. rubber black), and end cap 950. Wiring connector 960 is inserted in the other end.

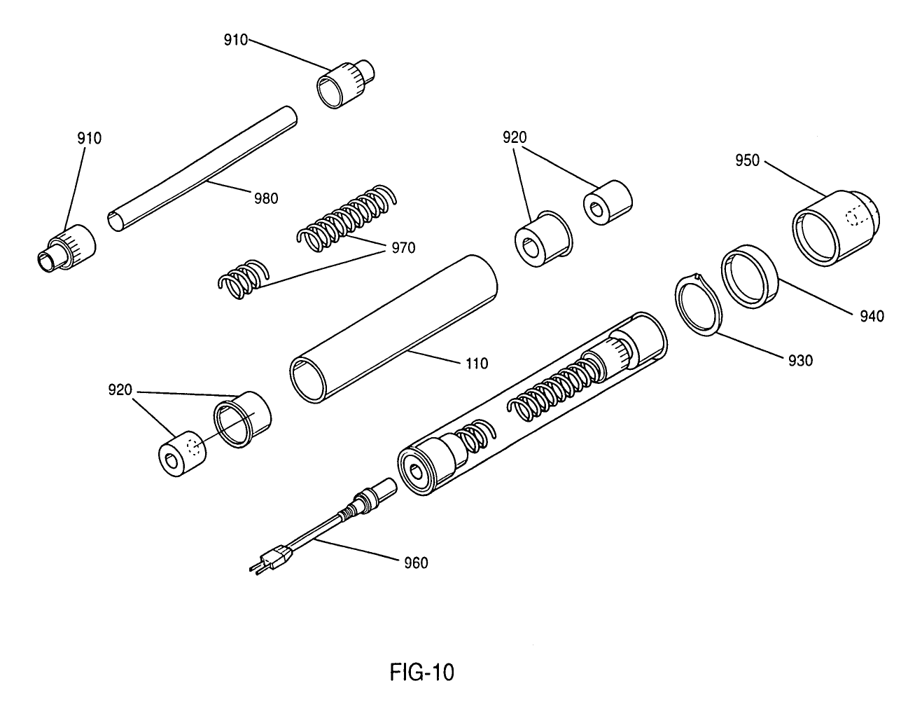

The embodiment of the invention depicted in FIG. 10 is similar to that in FIG. 9 except that the light source comprises spring lamp 970, which encircles PVC tube 980. The spring lamp may comprise different colored elements.

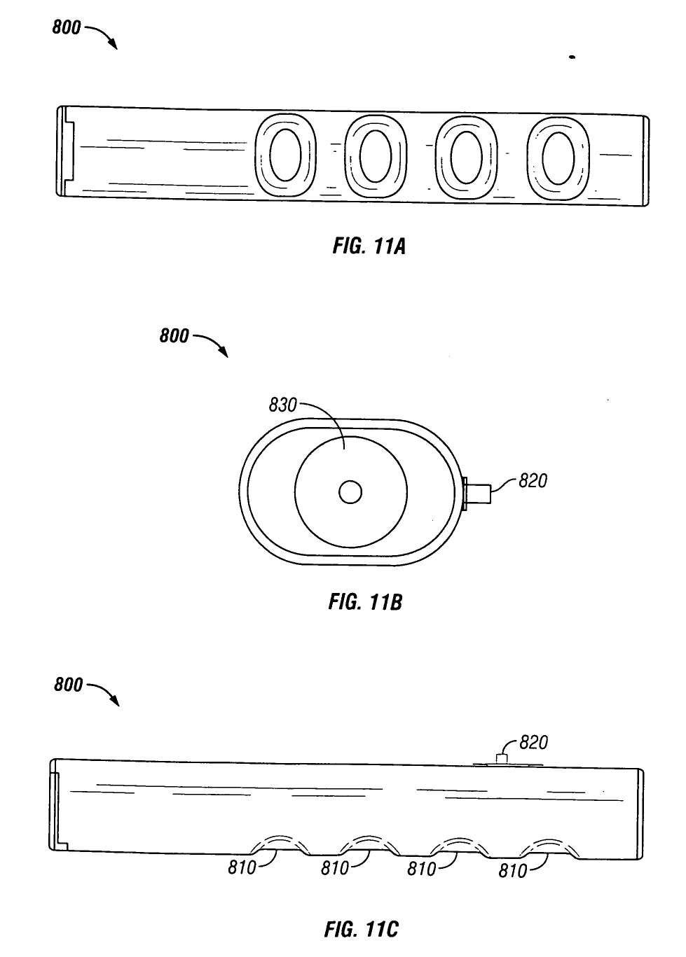

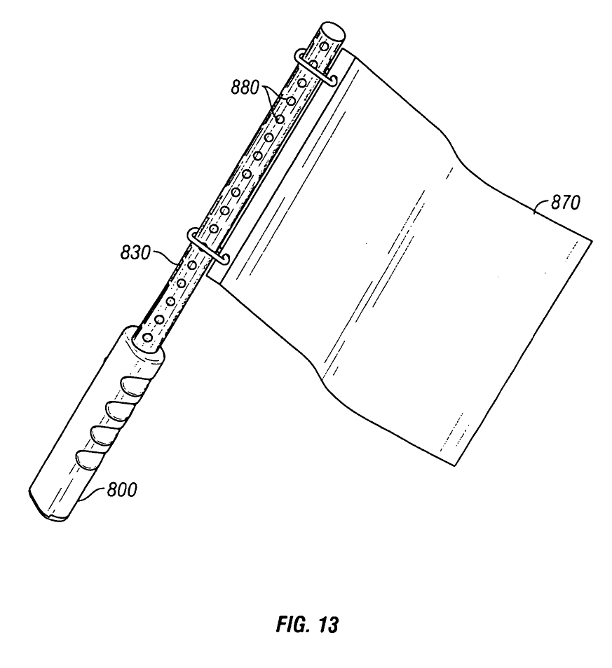

An alternative embodiment of the present invention comprises a portable, preferably handheld lighted wand for supporting a banner, shown generally in FIG. 13. FIGS. 11A-C shows front, end, and side views respectively of a preferred handle of this embodiment of the present invention. Handle 800 preferably comprises molded plastic but can comprise metal or any other material. Handle 800 preferably comprises one or more depressions 810 or finger grips for receiving the user's fingers as they grip handle 800. Switch 820 is preferably disposed on handle 800 on the side opposite from depressions 810 for easy actuation by the user's thumb. Switch 820 may be a simple on-off switch or may also control the brightness, color, illumination pattern, vibration, and/or any other characteristic of the present invention. Although handle 800 is not required for the present invention, its inclusion is preferable so the user does not have to grip support 830 directly.

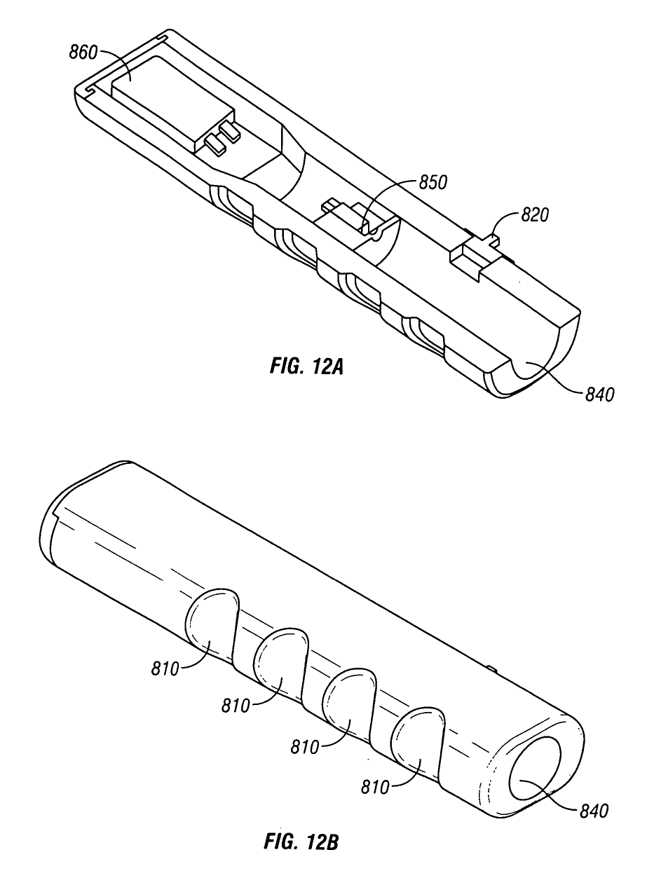

FIGS. 12A-B shows cutaway and perspective views of the handle of this embodiment. Handle 800 preferably comprises opening 840 for receiving support 830 and/or wires for connecting lighting elements 880 in support 830 to battery 860. Support 830 may be affixed to handle 800 by any means known in the art, including but not limited to an adhesive such as epoxy, a screw fitting, or a crimped fitting. Handle 800 optionally comprises vibrator motor 850 for vibrating handle 800 and support 830. Battery 860 preferably comprises at least one battery, preferably a 9V battery, although any battery or other power source may be used, including but not limited to a solar cell, DC adaptor, or AC plug.

FIG. 13 is a general depiction of the handheld embodiment of the present invention. Support 830 preferably comprises a transparent or translucent rigid tube. The tube may optionally be at least partially tinted, shaded, or comprise one or more colors. The tube preferably comprises acrylic or polystyrene, but any material may be used. Lighting elements 880 are preferably disposed within support 830 and preferably comprise one or more light emitting diodes (LEDs), although any light source, including but not limited to light bulbs, neon lights, string lights, or any of the sources described herein, may be used. Lighting elements 880 may comprise the same color or different colors; each lighting element may be illuminated continuously or blink or otherwise operate with a random or predetermined pattern of illumination. Lighting elements 880 may comprise their own packaging, such as an inner tube or light strip, for easy placement inside support 830. Lighting elements preferably illuminate the entire length and circumference of support 830, and preferably at least partially illuminate banner 870.

Any manner of attaching banner 870 to support 830 may be employed. Banner 870 is preferably affixed to support 830 via one or more grommets or other like devices. The grommets may encircle support 830, or may be clamped or tied to support 830 during assembly. For example, the top grommet may be clamped to the top of support 830 by a cap which is then affixed to support 830, and the bottom grommet may be inserted into opening 840 in handle 800 before support 830 is inserted in and/or affixed thereto. Banner 870 may alternately comprise one or more sleeves or pockets to receive and preferably secure support 830. The length of support 830 is preferably approximately the same as the height of banner 870, but it may be longer or shorter.

An alternative use contemplated by the present invention is a flag or banner mounted on a car or other vehicle. The light source may be battery powered, solar powered, have a plug to be inserted into the vehicle's 12 volt adaptor or cigarette lighter, or may be powered by other means. The flag might be a sports pennant or other banner. Alternatively, automobile dealers may use the invention to draw attention to and differentiate cars on their lot that are on sale, or the like. Blinking lighting elements may be used to attract attention to the pole and flag/banner.

Other uses that are contemplated by the present invention include: flags mounted on hats, poles with lighted animation (moving lights), Christmas lighting, belts, and an LED displaying letters spelling words.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A handheld lighted wand and banner assembly comprising:
a handle;
a support attached to said handle, said support comprising a hollow cylinder having no openings in its lateral surface;
one or more lighting elements disposed within said support; and
a banner attached to said support;
wherein said one or more lighting elements at least partially illuminate said banner and at least one portion of said support along substantially an entire length of said support.

2. The lighted wand and banner assembly of claim 1 wherein said support is clear, transparent, or translucent.

3. The lighted wand and banner assembly of claim 1 wherein said light elements are selected from the group consisting of light emitting diodes, rope lights, neon lights, light bulbs, fluorescent lights, filament lamps, incandescent lights, and fiber optics.

4. The lighted wand and banner assembly of claim 1 wherein said light elements comprise a characteristic selected from the group consisting of blinking, sequential illumination, patterned illumination, random illumination, single color, multiple colors, and varying brightness.

5. The lighted tube and banner assembly of claim 1 wherein said support comprises a material selected from the group consisting of polymer, acrylic, and polystyrene.

6. The lighted tube and banner assembly of claim 1 wherein said handle comprises finger grips.

7. The lighted tube and banner assembly of claim 1 wherein said handle comprises a switch for operating said assembly.

8. The lighted tube and banner assembly of claim 1 further comprising a vibrator motor.

9. The lighted tube and banner assembly of claim 1 wherein said banner is directly affixed to said support.

10. A method for illuminating a handheld tube and banner assembly comprising the steps of:
providing a support comprising a hollow cylinder having no openings in its lateral surface;
disposing one or more light elements within the support;
attaching a handle to the support;
affixing a banner to the support;
illuminating at least one portion of the support along substantially an entire length of the support; and
at least partially illuminating the banner.

11. The method of claim 10 wherein the support is clear, transparent, or translucent.

12. The method of claim 10 wherein the light elements are selected from the group consisting of light emitting diodes, rope lights, neon lights, light bulbs, fluorescent lights, filament lamps, incandescent lights, and fiber optics.

13. The method of claim 10 further comprising a step selected from the group consisting of blinking at least one of the light elements, sequentially illuminating the light elements, illuminating the light elements in a pattern, randomly illuminating the light elements, varying a color of the light elements, varying a brightness of the light elements, and vibrating the assembly.

14. The method of claim 10 wherein the support comprises a material selected from the group consisting of polymer, acrylic, and polystyrene.

15. The method of claim 10 further comprising the step of gripping the handle.

16. The method of claim 10 further comprising the step of operating a switch disposed on the handle.

17. The method of claim 10 wherein the affixing step comprises affixing the banner directly to the support.

18. The method of claim 10 wherein the affixing step comprises inserting the support into at least one grommet.

19. The method of claim 10 wherein the affixing step comprises affixing a cap to a top of the support.

20. The method of claim 10 wherein the attaching step comprises inserting the support into an opening in the handle.
